(19) United States
(12) Patent Application Publication
(10) Pub. No.: US 2022/0282533 A1
(43) Pub. Date: Sep. 8, 2022

(54) HANDLE ASSEMBLY FOR A MOTOR VEHICLE

(71) Applicant: Huf Hülsbeck & Fürst GmbH & Co. KG, Velbert (DE)

(72) Inventors: Heiko Schütz, Velbert (DE); Andreas Koch, Heiligenhaus (DE)

(73) Assignee: Huf Hülsbeck & Fürst GmbH & Co. KG, Velbert (DE)

(21) Appl. No.: 17/634,751

(22) PCT Filed: May 25, 2020
(86) PCT No.: PCT/EP2020/064387

§ 371 Date: Feb. 11, 2022

(30) Foreign Application Priority Data
Aug. 19, 2019 (DE) 10 2019 122 153.6

(51) Int. Cl. E05B 85/10; E05B 81/06

(52) U.S. Cl. CPC E05B 85/103; E05B 81/06

(57) ABSTRACT

A handle assembly for a motor vehicle has a support housing, a grip mounted on the support housing and movable between a retracted and extended position, a drive element movable along a main extension path, and a main extension lever which is movement-coupled to the drive element and pushes the grip into the extended position during a drive movement of the drive element along the main extension path. The drive element executes a drive movement divided into the main extension path and a pre-extension path preceding the main extension path. The drive element, during its drive movement along the pre-extension path, is movement-decoupled from the main extension lever, and a pre-extension lever is mounted rotatably on the support housing and pushes the grip towards the extended position during the drive movement of the drive element along the pre-extension path.

The invention is directed to a handle assembly for a motor vehicle, comprising a support housing, a grip which is movably mounted on the support housing, has a handle portion and is movable between a retracted position and an extended position, a drive element which is movably mounted on the support housing and is movable along a main extension path, and a main extension lever which is rotatably mounted on the support housing, movably supports a longitudinal end of the grip and is designed to be movement-coupled to the drive element and to push the grip into the extended position during a drive movement of the drive element along the main extension path, the handle portion, when the grip is installed in the motor vehicle, extending contour-flush with an outer surface of the motor vehicle in the retracted position and being extended with respect to the outer surface of the motor vehicle in an extension direction in the extended position.

Such a handle assembly is known, for example, from DE 10 2017 117 722 A1 and has a grip which is arranged contour-flush in its retracted position and which can be moved by a motor from the retracted position into an extended position. Such a grip is preferably used in electric cars, in which the grip, with a current-driven drive element, extends from its flush or flush-mounted retracted position, in which the grip is arranged for reducing air resistance, into the extended position when an authorized operator approaches the motor vehicle. Once the grip is no longer needed, it returns to the retracted position and disappears into the vehicle body to avoid producing air resistance. Due to the great cost pressure in the automotive industry, particularly small-sized motors are used as the drive element, which only apply a force to the grip to be extended that is designed for normal operation. However, if the grip is fixed in its retracted position in winter, for example, due to ice formation, the force of the drive element is usually not sufficient to break the grip loose and move it into its extended position, and therefore a possibility of de-icing must first be sought.

The object of the invention is to create a solution that provides a handle assembly for a motor vehicle in a structurally simple manner, by means of which handle assembly blocking of the movement of the grip or resistance to the movement of the grip at the beginning of the extension process can be overcome.

In a handle assembly of the type described at the outset, the object is achieved according to the invention in that during operation, the drive element can execute a drive movement which is divided into the main extension path and a pre-extension path preceding the main extension path, the drive element, during its drive movement along the pre-extension path, being movement-decoupled from the main extension lever, and a pre-extension lever being rotatably mounted on the support housing and being designed to push the grip toward the extended position during the drive movement of the drive element along the pre-extension path.

Advantageous and expedient embodiments and developments of the invention can be found in the dependent claims.

The invention provides a handle assembly for a motor vehicle which is characterized by a simple design and by a particular concept regarding overcoming a blockage or a resistance in the movement of the grip at the beginning of the extension process. The pre-extension lever ensures that a lever force is exerted on the grip in the direction of the extended position, which lever force acts before the force of the main extension lever. This makes it possible to apply a force to the grip before the actual extension process begins, by which the grip is moved only a short distance toward the extended position, without the grip reaching the extended position. Rather, by slightly moving the grip before the actual extension movement by means of the pre-extension lever, movement resistance or possible blocking of the movement of the grip is released.

It is particularly advantageous in an embodiment of the invention if the pre-extension lever is movement-coupled to the drive element during the drive movement of the drive element along the pre-extension path and is movement-decoupled from the drive element during the drive movement of the drive element along the main extension path, the pre-extension lever being designed to exert a pre-extension force on the grip during the drive movement of the drive element along the pre-extension path, and the pre-extension force being greater than a main extension force of the main extension lever acting on the grip during the drive movement of the drive element along the main extension path. This embodiment uses a single drive element for both the pre-extension lever and the main extension lever, so that an additional drive for the pre-extension lever is not required. In this case, the drive element for the pre-extension path and for the main extension path can supply a drive force of different strengths.

In a further embodiment of the invention, the pre-extension lever is mounted on the support housing so as to be rotatable about a swivel pin, the pre-extension lever having a first lever arm, which is designed to interact with the drive element, and a second lever arm, which is designed to interact with the grip. The two-arm design of the pre-extension lever allows flexible adjustment of the function and of the force of the pre-extension lever to be exerted on the grip.

Accordingly, in a further embodiment the first lever arm has a length which corresponds to at least twice the length of the second lever arm. As a result, this embodiment uses the lever principle, so that the pre-extension lever exerts as great a force as possible on the grip. In contrast to the main extension lever, this force has to act over only a short movement path of the grip and at the same time over a short movement path of the pre-extension lever, whereas the main extension lever, in contrast, has to cover a significantly longer path to extend the handle, so that the variability of the lever ratios for the main extension lever is severely restricted.

The variability with regard to the lever ratios, but also with regard to the installation situation, can advantageously be increased for the pre-extension lever if the first lever arm is designed to extend at an angle to the second lever arm.

A space-saving design is provided in a further embodiment of the invention in that the main extension lever is mounted on the support housing so as to be rotatable about a hinge pin, the drive element being mounted on the support housing so as to be rotatable about a motor-driven drive shaft and the drive movement of the drive element being formed as a rotational movement about the drive shaft from a starting position, in which the grip is in its retracted position, via a pre-extension position into a main extension position, in which the grip is in the extended position.

Furthermore, the invention provides in an embodiment that the drive element is designed to rotate in a first direction of rotation during its rotational movement along the pre-extension path and in a second direction of rotation during its rotational movement along the main extension path.

Accordingly, in an embodiment of the invention the first direction of rotation is opposite the second direction of rotation, the drive element being designed to pass through the starting position during its drive movement from the pre-extension position into the main extension position. In this embodiment, it is necessary to detect, for example by means of a button, a microswitch or a sensor, the position of the drive element and/or the grip; in this embodiment, the drive element performs a type of forward and reverse movement until the actual movement for extending the grip has taken place.

Alternatively, it is also conceivable according to another embodiment for the first direction of rotation and the second direction of rotation to be identical. As a result, detection means are not necessary, because the possible removal of a blockage and the extension of the grip involve a smooth and rectified movement of the drive element when the first and second directions of rotation are identical.

It is also structurally particularly advantageous in an embodiment of the invention if the drive element has a movement pin which is arranged at a radial distance from the drive shaft, the movement pin being designed, during the drive movement of the drive element along the main extension path, so as to push against the main extension lever, to rotate the main extension lever about the hinge pin and to move the grip into the extended position.

According to the last-mentioned embodiment, a movement decoupling for the main extension lever is possible in a structurally simple manner in that when the drive element moves along the pre-extension path, the movement pin is arranged at a distance from the main extension lever.

It is also structurally advantageous in an embodiment of the invention if the drive element has a push pin which is arranged at a radial distance from the drive shaft, the push pin being designed, during the drive movement of the drive element along the pre-extension path, so as to push against the first lever arm of the pre-extension lever, to rotate the pre-extension lever about the swivel pin and to move the grip toward the extended position.

For movement decoupling of the pre-extension lever, a further embodiment of the invention advantageously provides that when the drive element moves along the main extension path, the push pin is arranged at a distance from the pre-extension lever.

Finally, in an embodiment of the invention, a mechanical restoring element is provided which exerts a restoring force that pushes the grip toward the retracted position or holds the grip in the retracted position. The mechanical restoring element can, for example, be a restoring spring, so that no energy has to be supplied to the system of the handle assembly in order to reset the grip, as is the case, for example, for the motor-driven drive element.

It goes without saying that the features mentioned above and those to be explained below can be used not only in the specified combination, but also in other combinations or in isolation, without departing from the scope of the present invention. The scope of the invention is defined only by the claims.

Further details, features and advantages of the subject matter of the invention can be found in the following description in conjunction with the accompanying drawings, in which exemplary and preferred embodiments of the invention are shown.

In the drawings:

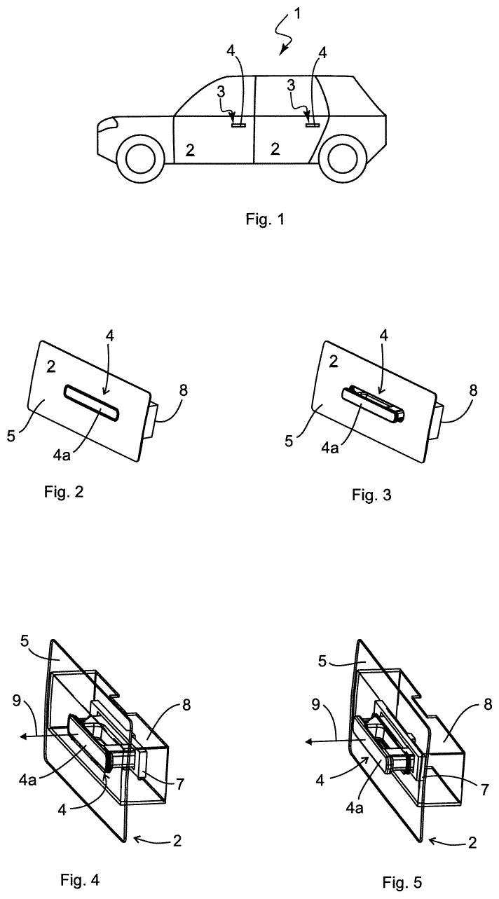

FIG. 1 is a schematic side view of a motor vehicle with a plurality of handle assemblies according to the invention,

FIG. 2 is a perspective view of the handle assembly according to the invention with a grip arranged contour- or surface-flush with an outer surface of a vehicle door in a retracted position,

FIG. 3 is a perspective view of the handle assembly according to the invention with a grip arranged in an extended position and extended relative to the outer surface of the vehicle door,

FIG. 4 is a perspective view of the grip mounted on a support housing in the retracted position,

FIG. 5 is a perspective view of the grip mounted on the support housing in the extended position,

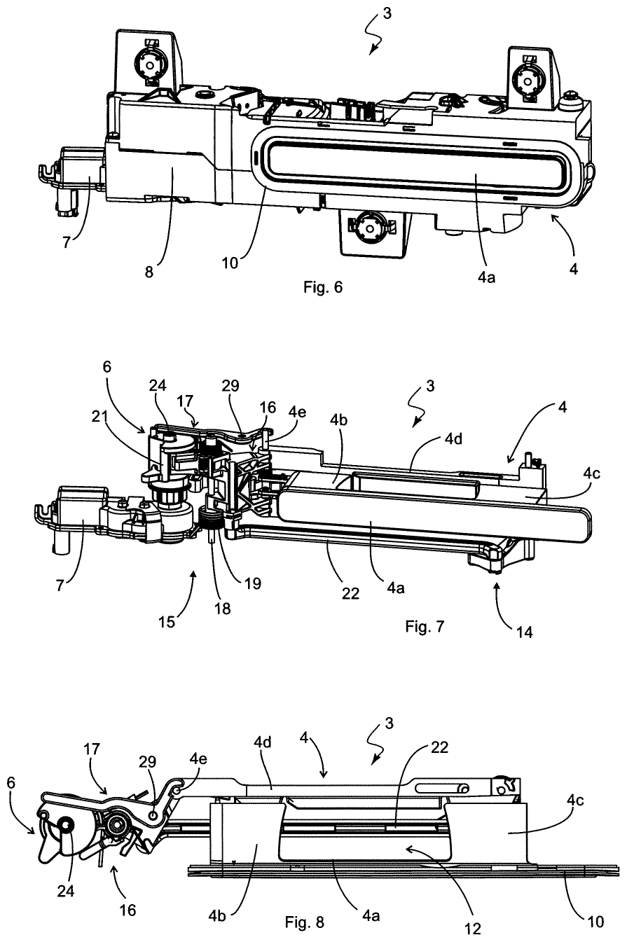

FIG. 6 is a perspective view of the handle assembly according to the invention,

FIG. 7 is a perspective view of the handle assembly according to the invention without a support housing,

FIG. 8 is a plan view of the handle assembly shown in FIG. 7,

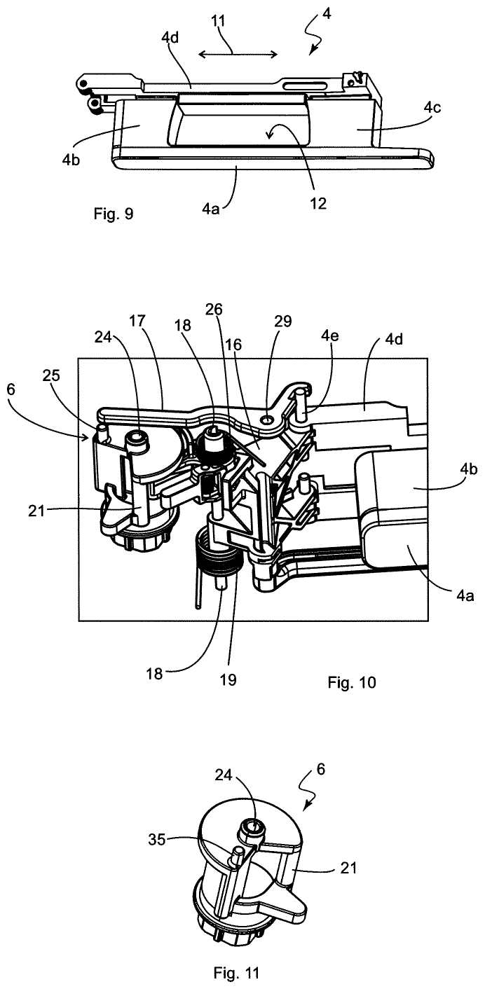

FIG. 9 is a perspective view of the grip of the handle assembly according to the invention,

FIG. 10 is a detailed plan view of a longitudinal end of the grip of the handle assembly according to the invention,

FIG. 11 is a perspective view of a drive element of the handle assembly according to the invention,

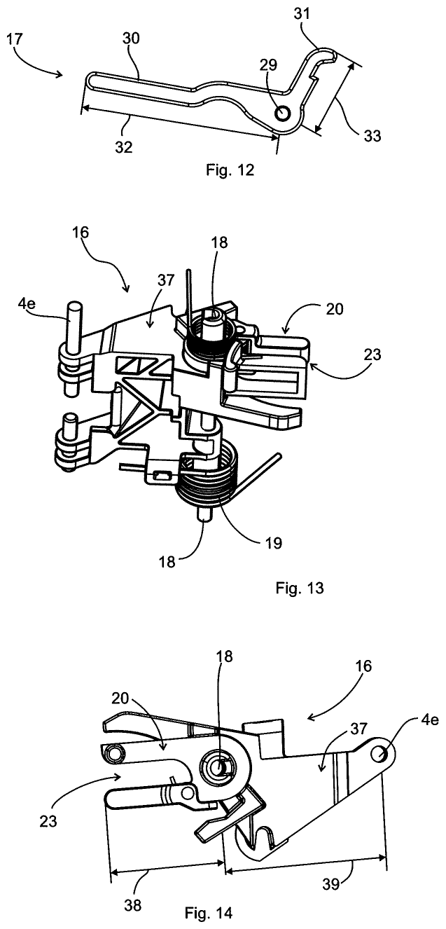

FIG. 12 is a plan view of a pre-extension lever of the handle assembly according to the invention,

FIG. 13 is a perspective view of a main extension lever of the handle assembly according to the invention,

FIG. 14 is a plan view of the main extension lever shown in FIG. 13,

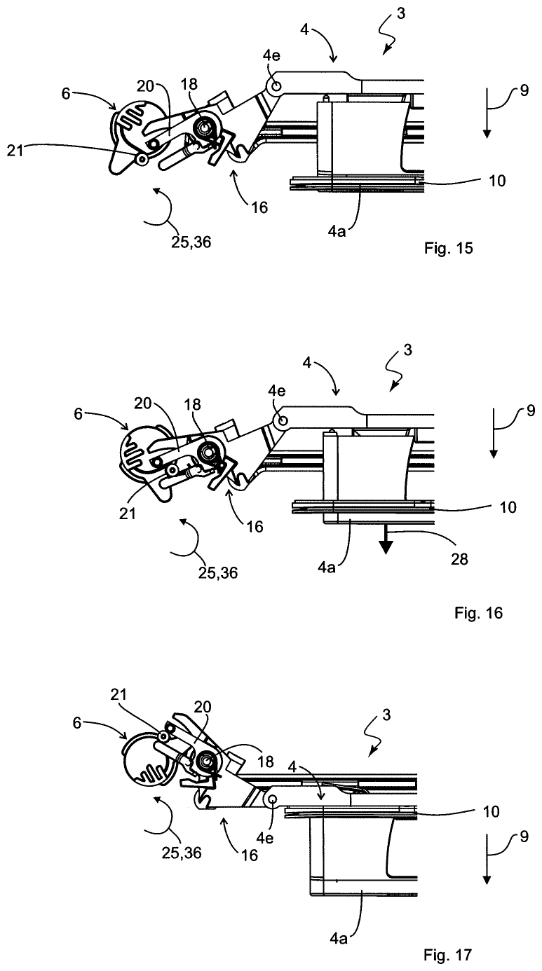

FIG. 15 is a plan view of a section of the handle assembly for a drive movement of extending the grip, the grip being arranged in the retracted position and the drive element being arranged in a starting position,

FIG. 16 is a plan view of a section of the handle assembly for a drive movement of extending the grip, the grip being arranged between the retracted position and the extended position in the direction of its extended position and the drive element moving along a main extension path,

FIG. 17 is a plan view of a section of the handle assembly for a drive movement of extending the grip, the grip being arranged in its extended position and the drive element being located at the end of the main extension path,

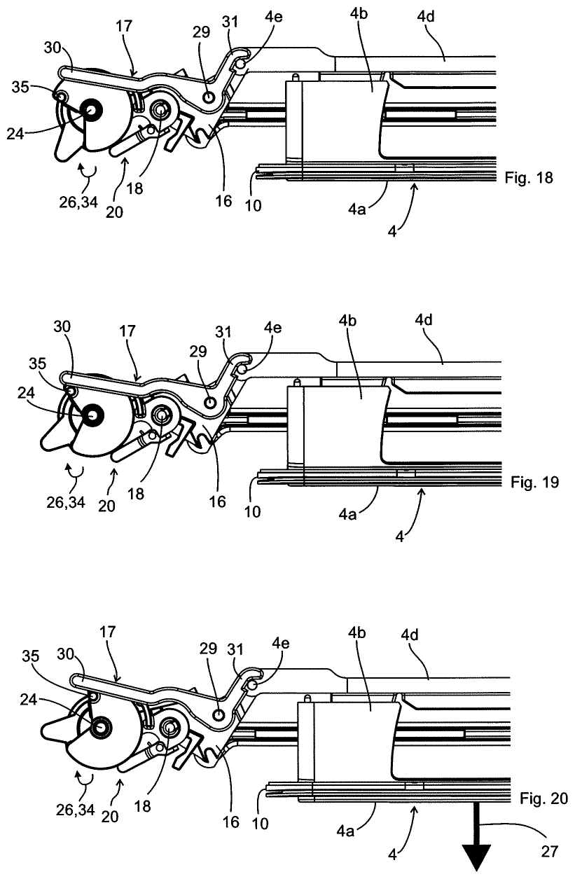

FIG. 18 is a plan view of a section of the handle assembly, with the grip being arranged in the retracted position,

FIG. 19 is a plan view of a section of the handle assembly, with the drive element moving along a pre-extension path,

FIG. 20 is a plan view of a section of the handle assembly, with the drive element being located at the end of the pre-extension path,

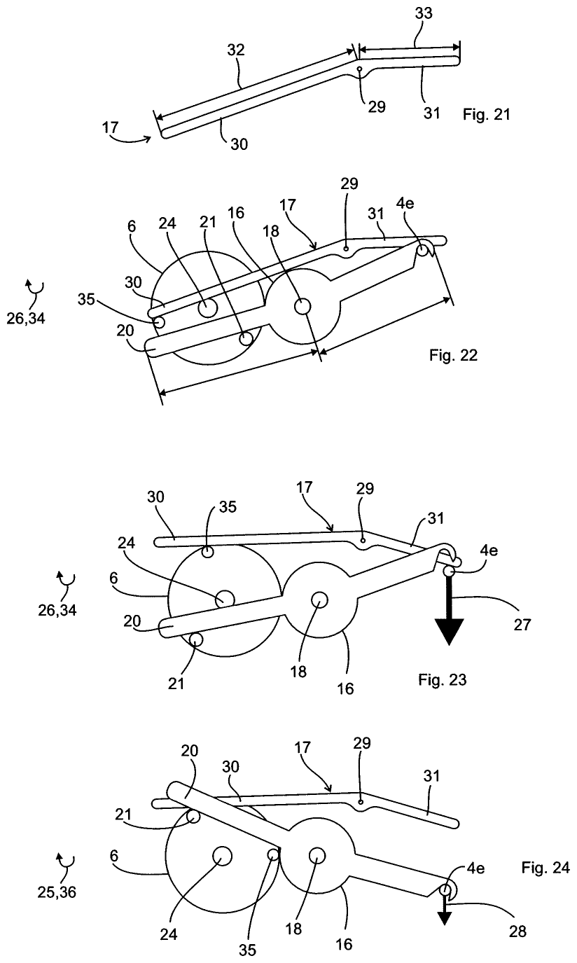

FIG. 21 is a plan view of a pre-extension lever according to an alternative embodiment,

FIG. 22 is a plan view of an alternative embodiment of the handle assembly, with the grip being arranged in its retracted position,

FIG. 23 is a plan view of the alternative embodiment of the handle assembly, with the drive element at the end of the pre-extension path, and

FIG. 24 is a plan view of the alternative embodiment of the handle assembly, with the drive element at the end of the main extension path.

FIG. 1 shows an example of a motor vehicle 1 in the form of a passenger car, which in the example has four vehicle doors 2 (two of which are shown in FIG. 1) which can each be opened by means of a relevant handle assembly 3 and in particular by means of a grip 4 of the handle assembly 3. The vehicle doors 2 are tightly locked by means of a door lock in each case and can each be opened from the outside by a movement of the grip 4. During normal operation of the handle assembly 3, this movement on the grip 4 consists of a pulling movement, which is detected, for example, by a micro-button, whereupon the lock of the vehicle door 2 is opened electrically. The associated vehicle door 2 can be opened by the corresponding movement of the grip 4. According to the invention, the handle assembly can be used not only in vehicle doors 2, but also in panels of motor vehicles.

FIGS. 2 to 5 are each a perspective view of one of the vehicle doors 2 and the grip 4 used to open the vehicle door 2, the grip 4 being shown in FIGS. 2 and 4 in a retracted position and in FIGS. 3 and 5 in an extended position. As can be seen in FIGS. 2 and 4, a handle portion 4a of the grip 4—when the handle assembly 3 is installed in the vehicle door 2—is arranged approximately flush with an outer surface 5 of the vehicle door 2, i.e. contour- or surface-flush. In this position, the grip 4 is in a retracted position in which it is not used. As an alternative to the surface-flush embodiment, the invention can also comprise other embodiments in which the grip 4 is arranged so as to be extended with respect to the outer surface 5 of the vehicle door 2 in such a way that the grip 4 cannot be operated or manipulated by an operator because the handle portion 4a of the grip 4 cannot be reached from behind by an operator in this position. It should also be noted that the outer surface 5 does not have to relate only to the exterior of a motor vehicle 1, but also to an outer surface arranged inside the motor vehicle 1, such as the outer surface of a glove compartment, or an outer surface located on the outside of the motor vehicle 1.

From the retracted position shown in FIGS. 2 and 4, the grip 4 can be transferred into an extended position shown in FIGS. 3 and 5, in which the handle portion 4a of the grip 4 projects with respect to the outer surface 5 of the vehicle door 2 and is extended in comparison with the retracted position. Accordingly, the handle portion 4a of the grip 4 is arranged so as to protrude from the vehicle door 2 in the extended position. In the extended position that protrudes or extends from the outer surface 5, an operator can reach behind the handle portion 4a of the grip 4 and operate or handle it in order to open the vehicle door 2. The grip 4 is transferred from the retracted position to the extended position by means of a drive element 6 of the handle assembly 3, which drive element is moved by an electric motor 7 in the embodiment shown. Proximity sensors or other sensors can be provided for normal operation in order to start up the electric motor 7 accordingly and thereby move the drive element 6 so that the grip 4 is brought from the retracted position into the extended position as soon as an operator approaches the handle assembly 3 or the grip 4. For this purpose, proximity sensors known from the prior art may be installed in the grip 4, which sensors send a signal to a vehicle control device upon detection of an authorized operator or ID transmitter, whereby the electric motor 7 is put into operation and causes the extension of the grip 4 into the extended position. The grip 4 is movably mounted on a support housing 8 of the handle assembly 3, as can be seen in FIGS. 2 to 5, and is moved in an extension direction 9 (see e.g. FIGS. 4 and 5) during the movement from the retracted position to the extended position, the support housing 8 being fastenable to a vehicle body panel of the vehicle door 2.

The handle assembly 3 according to the invention and the components thereof are shown in detail in FIGS. 6 to 14. FIG. 6 is a perspective view of the handle assembly 3, with the support housing 8 covering the mounting of the individual components of the handle assembly 3 to protect them from damage and dirt. In this case, only the electric motor 7 protrudes laterally from the support housing 8. The support housing 8 has three attachment brackets, through which screw means extend, in order to be able to attach the support housing 8 to a body panel of the motor vehicle 2. Furthermore, the handle portion 4a of the grip 4, which handle portion is surrounded by a seal 10, can be seen in FIG. 6. The seal 10 is shown in contrast to the support housing 8 in FIGS. 15 to 17 and serves as a fixed reference point for the relative movement of the grip 4 with respect to the support housing 8.

In contrast, the seal 10 and the support housing 8 are not shown in FIG. 7, and therefore the drive element 6 of the handle assembly 3 can now be seen, for example. As can also be seen in FIG. 7, the grip 4 is stirrup-shaped and, in addition to the handle portion 4a, has a handle plate 4d and two connecting fingers 4b and 4c spaced apart from one another in the longitudinal direction 11 (see also e.g. FIG. 9) of the grip 4. The connecting fingers 4b and 4c connect the handle portion 4a to the handle plate 4d, with the handle plate 4d being arranged substantially flush with the outer surface 6 when the grip 4 is in the extended position. As FIG. 9 shows in this context, the handle portion 4a, the connecting fingers 4b, 4c and the handle plate 4d form an access region 12 into which the hand of an operator reaches in order to grasp the grip 4 and operate it. The handle plate 4d is movably mounted on the support housing 8 at both of its longitudinal ends via a lever mechanism 14 and via an extension mechanism 15, the invention relating to the extension mechanism 15, which is arranged in the region of the electric motor 7 and is responsible for the movement of the grip 4 is, whereas the lever mechanism 14 follows the movement of the extension mechanism 15 at the other longitudinal end of the handle plate 4d. The extension mechanism 15, which is movement-connected to the lever mechanism 14 via a coupling rod 22 (see e.g. FIG. 7), is part of the handle assembly 3 according to the invention and, in addition to the drive element 8, comprises a main extension lever 16 and a pre-extension lever 17, which are described below in detail.

The grip 4 is pivotally connected via the handle plate 4d to the main extension lever 16 via a coupling shaft 4e which moves with the handle plate 4d and is fixed to the handle plate 4d, as can be seen, for example, in FIGS. 7, 8 and 10. Furthermore, the main extension lever 16 is mounted on the support housing 8 so as to be rotatable about a hinge pin 18. A mechanical restoring element 19 in the form of a torsion spring is wound around the hinge pin 18. The mechanical restoring element 19 is supported on the main extension lever 16 and on the support housing 8 via its two spring arms and exerts a restoring force on the grip 4, the restoring force pushing the grip 4 moved out of the retracted position toward the retracted position or holding the grip 4 arranged in the retracted position in the retracted position. In order to move the grip 4 out of the retracted position, the restoring force must therefore be overcome, the mechanical restoring element 19 acting on the main extension lever 16 and pushing the grip 4 toward the retracted position via the main extension lever 16 or holding said grip in the retracted position.

For a movement coupling between the grip 4 and the drive element 6, the main extension lever 16 is provided, which is used to move the grip 4 from the retracted position to the extended position, as shown in FIGS. 15 to 17 for a sectional plane below the pre-extension lever 17 in each case. The main extension lever 16 is mounted so as to be rotatable about the hinge pin 18 and has a U-shaped movement attachment 20 (see e.g. FIGS. 13 and 14), which is aligned with its opening 23 facing the drive element 6. The movement attachment 20 represents a lever arm of the two-armed main extension lever 16, the other lever arm 37 being movement-coupled to the handle plate 4d of the grip 4 via the coupling shaft 4e. The other lever arm 37 is only slightly longer than the lever-arm-like movement attachment 20, so that the force transmitted from the drive element 6 to the movement attachment 20 is also transmitted from the other lever arm 37 to the grip 4. A length 38 of the movement attachment 20 is therefore at most the same size as the length 39 of the other lever arm 37.

During a drive movement of the drive element 6, a movement pin 21 formed on the drive element 6 (see e.g. FIG. 11) moves into the opening 23 of the movement attachment 20, the movement pin 21 coming into contact with one of the two legs of the U-shaped movement attachment 20 and pressing against this leg in order to rotate the main extension lever 16 about the hinge pin 18. The drive element 6 is mounted on the support housing 8 so as to be rotatable about a motor-driven drive shaft 24 (see e.g. FIG. 7). Accordingly, a drive movement of the drive element 6 is a rotational movement about the drive shaft 24, the movement pin 21 of the drive element 6 being arranged and formed at a distance from the drive shaft 24.

In the manner described above, the drive element 6 is connected in a movement-coupled manner to the grip 4 via the main extension lever 16 from the time at which the movement pin 21 comes into contact with the movement attachment 20 and presses against the movement attachment 20 in order to move the grip 4 out of the retracted position into the extended position, which will be described in more detail below. FIGS. 15 to 17 show different arrangements for an extension movement of the grip 4 along a main extension path 25, with the seal 10 being shown as a reference point and representative of the support housing 8. In FIGS. 15 to 17, the drive element 6 is shown partially in section in order to allow a view of the movement attachment 20 and the movement pin 21.

In FIG. 15, the grip 4 is arranged in its retracted position, whereas the drive element 6 is arranged in a starting position. In this arrangement of FIG. 15, the drive element 6 and the grip 4 are movement-decoupled because the movement pin 21 is arranged at a distance from the movement attachment 20. Therefore, in the position shown in FIG. 15, the restoring force of the mechanical restoring element 19 is the only force that holds the grip 4 back in the retracted position due to the movement decoupling. In this operating state, the movement pin 21 of the drive element 6 is arranged at a distance from the U-shaped movement attachment 20 and is not in contact therewith.

If the drive element 6 is now put into operation from the arrangement shown in FIG. 15 in order to move along the main extension path 25, the drive element 6 rotates counterclockwise, as a result of which the movement pin 21 moves towards the U-shaped movement attachment 20 and finally enters the opening 23, thus producing the movement coupling between the drive element 6 and the grip 4. The main extension path 25 serves to move the grip 4 from the retracted position to the extended position in which a user can grasp the grip 4 and operate it. In the opening 23 of the movement attachment, the movement pin 21 then rests against one of the two legs of the movement attachment 20 during the movement along the main extension path 25 and pushes the grip 4 toward the extended position, as can be seen in FIG. 16. In FIG. 17, the movement pin 21 of the drive element 6 has then rotated the main extension lever 16 about the hinge pin 18 in such a way that the grip 4 is arranged in the extended position, in which a user of the handle assembly 3 can then reach behind the grip 4 and operate it. This movement of the drive element 6 takes place along the main extension path 25, which is shown by way of example using the arrow 25 in FIGS. 15 to 17. During the drive movement of the drive element 6 to move the grip 4 toward the extended position along the main extension path 25, the movement pin 21 is arranged at a distance from the movement attachment 20 at the beginning of the movement of the drive element 6, so that the grip 4 and the drive element 6 are movement-decoupled from one another. As soon as the movement pin 21 comes into contact with the movement attachment 20, the drive element 6 is movement-coupled to the grip 4 via the main extension lever 16. In FIG. 17, the movement pin 21 of the drive element 6 has then pivoted the main extension lever 16 to such an extent that the grip 4 is now arranged in its extended position. In the process, the drive element 6 has completely covered the main extension path 25. The drive element 6 can thus be moved along the main extension path 25 during an extension movement of the grip 4. During a drive movement of the drive element 6 along the main extension path 25, the grip 4 and the drive element 6 are movement-coupled to one another. Accordingly, the movement pin 21 of the drive element 6 is designed, during the drive movement of the drive element 6 along the main extension path 25, so as to rotate the main extension lever 16 about the hinge pin 18 and to move the grip 4 into the extended position. At the beginning of the extension movement, however, the grip 4 and the drive element 6 are movement-decoupled from one another along a pre-extension path 26, the movement along the pre-extension path 26 serving to remove a possible blockage of the grip movement.

In particular, the above-described movement of the grip 4 into the extended position is preceded by a movement sequence in which the drive element 6 moves along the pre-extension path 26. The grip 4 is moved along the pre-extension path 26 toward the extended position with a pre-extension force 27 that is greater than a main extension force 28 exerted on the grip 4 by the main extension lever 16. This pre-extension force 27 is provided by the pre-extension lever 17, which can be seen in FIGS. 7, 8, 10 and 12 for the first embodiment and in FIG. 21 for a second embodiment. However, during the movement along the pre-extension path 26, the grip 4 does not reach the extended position. Rather, the grip 4 is only moved toward the extended position in order to release a blockage that would prevent the grip 4 from being extended along the main extension path 25, for example due to ice formation, because the main extension force 28 of the drive element 6 acting on the main extension lever 16 and thus the grip 4 is too low to overcome such a blockage. The drive movement of the drive element 6 upstream of the main extension path 25 moves the grip 4 only a partial distance out of the retracted position toward the extended position, without reaching the extended position.

With reference to FIGS. 12 and 21 and consequently with regard to the two embodiments, the pre-extension lever 17 is mounted on the support housing 8 so as to be rotatable about a swivel pin 29. The pre-extension lever 17 has two arms and therefore has a first lever arm 30 and a second lever arm 31 (see FIGS. 12 and 21). The first lever arm 30 is designed to interact with the drive element 6, whereas the second lever arm 31 is designed to interact with the grip 4. The interaction and thus a movement coupling of the second lever arm 31 of the pre-extension lever 17 and the grip 4 is realized by the coupling shaft 4e, which is arranged in the movement path of the pre-extension lever 17 when the pre-extension lever 17, during the drive movement of the drive element 6, rotates about the swivel pin 29 along the pre-extension path 26. In order to overcome a blockage during the extension movement of the grip 4, it is desirable according to the invention for the grip 4 to be moved out of the retracted position with great force. For this purpose, in the invention the first lever arm 30 has a length 32 which corresponds to at least twice the length 33 of the second lever arm 31, as can be seen in FIGS. 12 and 21. The length 32 of the first lever arm 30 preferably corresponds to three times the length 33 of the second lever arm 31. Depending on the installation space situation, it may be appropriate for the first lever arm 30 to extend at an angle to the second lever arm 31, as can be seen, for example, in the first embodiment in FIG. 12.

FIGS. 18 to 20 show the drive movement of the drive element 6 for the pre-extension path 26 for the first embodiment, the drive movement along the main extension path 25 temporally following the drive movement along the pre-extension path 26. In FIG. 18, the grip 4 is in the retracted position and the drive element 6 is in a starting position, so that the grip 4 is arranged contour-flush with the outer surface 5 of the motor vehicle 2. If it is now detected that the grip 4 is to be moved from the retracted position to the extended position, according to the first embodiment the drive element 6 is set in drive motion along the pre-extension path 26 and reaches the position shown in FIG. 19. The drive movement of the drive element 6 along the pre-extension path 26 is a rotational movement about the drive shaft 24 in a first direction of rotation 34 (clockwise), the drive element 6 being moved out of a starting position (see FIG. 18). In FIG. 19, the drive element 6 is arranged in a position between the starting position (see FIG. 18) and a pre-extension position (see FIG. 20), the drive element 6 having reached the end of the pre-extension path 26 in the pre-extension position. The drive element 6 has a push pin 35 (see e.g. FIGS. 10, 11 and 18 to 20) which is arranged at a radial distance from the drive shaft 24. In the intermediate position shown in FIG. 19, the push pin 35 comes into contact with the first lever arm 30 of the pre-extension lever 17. Upon further movement of the drive element 6 into the pre-extension position shown in FIG. 20, the push pin 35 then presses further against the first lever arm 30 and thereby pivots the pre-extension lever 17 about the swivel pin 29. Consequently, the push pin 35 is designed, during the drive movement of the drive element 6 along the main extension path 26, so as to push against the first lever arm 30 of the pre-extension lever 17, to rotate the pre-extension lever 17 about the swivel pin 29 and to move the grip 4 toward the extended position. As a result, the second lever arm 31 presses against the coupling shaft 4e and thereby presses the grip 4 toward the extended position, so that the grip 4 moves slightly out of the outer surface, which is represented by the seal 10 in FIG. 20, and a blockage is resolved. A rotational movement then takes place in a direction of rotation opposite the first direction of rotation 34, so that the drive element 6 returns to the starting position, and therefore the components of the handle assembly 3 according to the invention in the first embodiment again assume the arrangement shown in FIG. 15 and, in order to extend the grip 4, the drive element 6 moves along its main extension path 25, as shown in FIGS. 15 to 17 and as already described above. The drive element 6 rotates along the main extension path 25 in the second direction of rotation 36 (counterclockwise). Consequently, the drive element 6 is designed to rotate in the first direction of rotation 34 during its rotational movement along the pre-extension path 26 and in a second direction of rotation 36 during its rotational movement along the main extension path 25 (see FIGS. 15 to 17). It is characteristic of the first embodiment that the first direction of rotation 34 is opposite the second direction of rotation 36, the drive element 6 being designed to pass through the starting position during its drive movement from the pre-extension position into the main extension position and the movement pin 21 being arranged at a distance from the main extension lever 16.

FIGS. 22 to 24 show the drive movement of the drive element 6 for the second embodiment. The drive movement of the drive element 6 shown in FIG. 22 to FIG. 23 for the second embodiment takes place along the pre-extension path 26. The drive movement of the drive element 6 from FIG. 23 to FIG. 24 then takes place along the main extension path 25, with the drive element 6 in the second embodiment not passing through the starting position as in the first embodiment. Rather, there is a rectified movement of the drive element in the same direction with a smooth transition from the pre-extension path 26 to the main extension path 25. In the arrangement shown in FIG. 22, the grip 4, which is represented by the coupling shaft 4e, is in the retracted position and the drive element 6 is in its starting position. In order to extend the grip 4, the drive element 6 is now put into operation, with the drive element 6 then rotating in the first direction of rotation 34 (clockwise). The push pin 35 pushes against the first lever arm 30 of the pre-extension lever 17 and rotates the extension lever 17 about the swivel pin 29, so that the position shown in FIG. 23 is reached, in which the drive element 6 is in the pre-extension position and the grip 4, which is represented by the coupling shaft 4e, is arranged so as to be moved out of the present retracted position shown in FIG. 22 toward the extended position. The pre-extension force 27 acts on the grip 4 via the pre-extension lever 17, as shown schematically in FIG. 23. The drive movement of the drive element 6 from FIG. 23, in which the drive element 6 is in the pre-extension position, to FIG. 24, in which the drive element 6 is in a main extension position, then takes place along the main extension path 25, the drive element 6 rotating in the second direction of rotation 36, and the first direction of rotation 34 and the second direction of rotation 36 being identical.

In summary, a handle assembly 3 has been described above which is characterized in that during operation, the drive element 6 executes a drive movement which is divided into the main extension path 25 and the pre-extension path 26 preceding the main extension path 25, the drive element 6, during its drive movement along the pre-extension path 26, being movement-decoupled from the main extension lever 16. This is achieved in that during a movement of the drive element 6 along the pre-extension path 26, the movement pin 21 is arranged at a distance from the main extension lever 16. The pre-extension lever 17 rotatably mounted on the support housing 8 is also designed to push the grip 4 toward the extended position during the drive movement of the drive element 6 along the pre-extension path 26.

For this purpose, according to the two embodiments, the pre-extension lever 17 is movement-coupled to the drive element 6 during the drive movement of the drive element 6 along the pre-extension path 26, whereas the pre-extension lever 17 is movement-decoupled from the drive element 6 during the drive movement of the drive element 6 along the main extension path 25. For this purpose, during a movement of the drive element 6 along the main extension path 25, the push pin 35 is arranged at a distance from the pre-extension lever 17. The pre-extension lever 17 is also designed to exert the pre-extension force 27 on the grip 4 during the drive movement of the drive element 6 along the pre-extension path 26, the pre-extension force 27 being greater than the main extension force 28 of the main extension lever 16 acting on the grip 4 during the drive movement of the drive element 6 along the main extension path 25. The drive movement of the motor-driven drive element 6 is formed as a rotational movement about the drive shaft 33, the drive element 6 moving in rotation from the starting position, in which the grip 4 is in its retracted position, via the pre-extension position to the main extension position, in which the grip 4 is in the extended position. The movement pin 21 is designed, during the drive movement of the drive element 6 along the main extension path 25, so as to push against the main extension lever 16, to rotate the main extension lever 16 about the hinge pin 18 and to move the grip 4 into the extended position. Furthermore, the movement pin 21 and the push pin 35 are arranged at different peripheral positions of the driving member 6 with respect to the drive shaft 24.

Of course, the invention described above is not limited to the embodiments described and illustrated. It is evident that numerous modifications, which are obvious to a person skilled in the art according to the intended application, can be made to the embodiments shown in the drawings without departing from the scope of the invention defined by the claims.

1. A handle assembly for a motor vehicle, comprising a support housing, a grip which is movably mounted on the support housing, a handle portion and is movable between a retracted position and an extended position, a drive element which is movably mounted on the support housing and is movable along a main extension path, and a main extension lever which is rotatably mounted on the support housing, movably supports a longitudinal end of the grip and is designed to be movement-coupled to the drive element and to push the grip into the extended position during a drive movement of the drive element along the main extension path, the handle portion, when the grip is installed in the motor vehicle, extending flush with an outer surface of the motor vehicle in the retracted position and being extended with respect to the outer surface of the motor vehicle in an extension direction in the extended position,
wherein
during operation, the drive element can execute a drive movement which is divided into the main extension path and a pre-extension path preceding the main extension path, the drive element, during its drive movement along the pre-extension path, being movement-decoupled from the main extension lever, and a pre-extension lever being rotatably mounted on the support housing and being designed to push the grip toward the extended position during the drive movement of the drive element along the pre-extension path.

2. The handle assembly according to claim 1, wherein the pre-extension lever is movement-coupled to the drive element during the drive movement of the drive element along the pre-extension path and is movement-decoupled from the drive element during the drive movement of the drive element along the main extension path, the pre-extension lever being designed to exert a pre-extension force on the grip during the drive movement of the drive element along the pre-extension path, and the pre-extension force being greater than a main extension force of the main extension lever acting on the grip during the drive movement of the drive element along the main extension path.

3. The handle assembly according to either claim 1, wherein the pre-extension lever is mounted on the support housing so as to be rotatable about a swivel pin, the pre-extension lever having a first lever arm, which is designed to interact with the drive element, and a second lever arm, which is designed to interact with the grip.

4. The handle assembly according to claim 3, wherein the first lever arm has a length which corresponds to at least twice the length of the second lever arm.

5. The handle assembly according to either claim 3, wherein the first lever arm extends at an angle to the second lever arm.

6. The handle assembly according to claim 3, wherein the main extension lever is mounted on the support housing so as to be rotatable about a hinge pin the drive element being mounted on the support housing so as to be rotatable about a motor-driven drive shaft and the drive movement of the drive element being formed as a rotational movement about the drive shaft from a starting position, in which the grip is in its retracted position, via a pre-extension position into a main extension position, in which the grip is in the extended position.

7. The handle assembly according to claim 6, wherein the drive element is designed to rotate in a first direction of rotation during its rotational movement along the pre-extension path and in a second direction of rotation during its rotational movement along the main extension path.

8. The handle assembly according to claim 7, wherein the first direction of rotation is opposite the second direction of rotation, the drive element being designed to pass through the starting position during its drive movement from the pre-extension position into the main extension position.

9. The handle assembly according to claim 7, wherein the first direction of rotation and the second direction of rotation are identical.

10. The handle assembly according to claim 6, wherein the drive element has a movement pin which is arranged at a radial distance from the drive shaft, the movement pin being designed, during the drive movement of the drive element along the main extension path, so as to push against the main extension lever, to rotate the main extension lever about the hinge pin and to move the grip into the extended position.

11. The handle assembly according to claim 10, wherein during a movement of the drive element along the pre-extension path, the movement pin is arranged at a distance from the main extension lever.

12. The handle assembly according to claim 6, wherein the drive element has a push pin which is arranged at a radial distance from the drive shaft, the push pin being designed, during the drive movement of the drive element along the main extension path, so as to push against the first lever arm of the pre-extension lever, to rotate the pre-extension lever about the swivel pin and to move the grip toward the extended position.

13. The handle assembly according to claim 12, wherein during a movement of the drive element along the main extension path, the push pin is arranged at a distance from the pre-extension lever.

14. The handle assembly according to claim 1, wherein a mechanical restoring element is provided which exerts a restoring force that pushes the grip toward the retracted position or holds the grip in the retracted position.
